(19) United States
(12) Patent Application Publication
(10) Pub. No.: US 2010/0148668 A1
(43) Pub. Date: Jun. 17, 2010

(54) HALOGEN INCANDESCENT LAMP

(75) Inventors: Matthias Damm, Gaimersheim (DE); Andreas Nittke, Pietenfeld (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/626,643

(22) Filed: Nov. 26, 2009

(30) Foreign Application Priority Data
Dec. 11, 2008 (DE) 10 2008 061 776.8

(51) Int. Cl. H01K 1/50

(52) U.S. Cl. 313/579

(57) ABSTRACT

A halogen incandescent lamp is provided in various embodiments. The halogen incandescent lamp may include a bulb in which there are accommodated a luminous element and a fill with a halogen-containing additive; the halogen being at least one of iodine and bromine, wherein there is accommodated in the interior of the bulb a layer which can be activated at suitable temperatures, the layer containing at least one of bromine, chlorine, fluorine and oxides or sulfides and is arranged such that it can be touched by the luminous element in the case when the latter is passed through and, during operation of the lamp, ensures the lamp is quickly switched off owing to the release of a reactive substance.

### CROSS-REFERENCE TO RELATED APPLICATION

This application claims priority to German Patent Application Serial No. 10 2008 061 776.8, which was filed Dec. 11, 2008, and is incorporated herein by reference in its entirety.

### TECHNICAL FIELD

The invention relates to a halogen incandescent lamp. Such halogen incandescent lamps are intended, by way of example, for operation at high voltage (HV), typically at 100 to 250 V.

### BACKGROUND

WO 2007/105121 discloses a halogen incandescent lamp that includes a complicated switch-off mechanism.

With halogen lamps for line voltage, a substantial filament sag can occur given malfunctions caused by the precursor materials or the production process. When there is a severe filament sag, the filament can come to rest on the bulb in the extreme case. The bulb temperature rises steeply owing to the bulb being touched by the filament. Depending on lamp geometry and design of the filament (power/length), the temperature can rise so steeply that devitrification of the bulb wall consisting of silica glass sets in (that is to say, it is usually the case that the smaller the bulb diameter, or the smaller the bulb wall thickness, or the larger the ratio of power and filament length, the higher the temperatures that are reached). This devitrification can cause the lamp to explode in the extreme case.

It is proposed in WO 20071105121, for example, to surround the middle of a filament with a metallic ring, which is connected to a power supply, in such a way that the filament lies in the axis of the ring. The metallic ring is connected to a power supply. When sagging, the filament touches this ring, half the filament then being short circuited. The current flow thereby increased causes the internal fuse to respond, and thus reliably switches off the lamp. Further embodiments functioning according to the same principle are described in said patent. This principle cannot be directly applied to lamps without a frame, for example knob lamps, because the lamps include no frame parts, frequently also called electrodes.

To date, it has not been possible to build lamps that can explode in the worst case in the event of devitrification should the filament come to rest, or such lamps can be operated only in stable shieldings (reflectors).

### SUMMARY OF THE INVENTION

A halogen incandescent lamp is provided in various embodiments. The halogen incandescent lamp may include a bulb in which there are accommodated a luminous element and a fill with a halogen-containing additive; the halogen being at least one of iodine and bromine, wherein there is accommodated in the interior of the bulb a layer which can be activated at suitable temperatures, the layer containing at least one of bromine, chlorine, fluorine and oxides or sulfides and is arranged such that it can be touched by the luminous element in the case when the latter is passed through and, during operation of the lamp, ensures the lamp is quickly switched off owing to the release of a reactive substance.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a halogen incandescent lamp in side view;

FIG. 2 shows a further exemplary embodiment of a halogen incandescent lamp;

FIG. 3 shows a further exemplary embodiment of a halogen incandescent lamp; and

FIG. 4 shows an exemplary embodiment of a soffit lamp.

### DESCRIPTION

The following detailed description refers to the accompanying drawings that show, by way of illustration, specific details and embodiments in which the invention may be practiced.

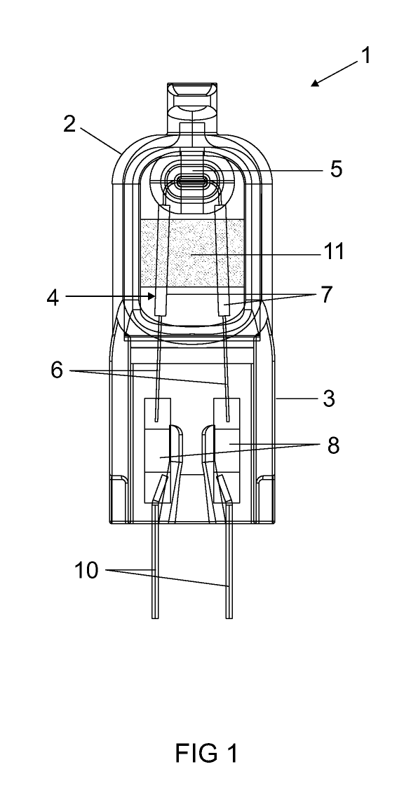

An exemplary embodiment of an HV halogen incandescent lamp 1 is shown in FIG. 1. It has a burner or bulb 2 that is closed at one end. This is done by means of a pinch 3. Seated in the interior of the burner is a luminous element 4 that is in the shape of a U with two sections 7. It is held without a frame by means of a knob 5 that fixes a connecting piece between the two luminous sections. The sections 7 end in inner supply leads 6, which lead to foils 8 in the pinch 3. Outer supply leads 10 lead outward from the foils. The fill of the lamp may be a conventional halogen-containing fill, the halogen compound being based on the halogens iodine and/or bromine It is also possible to use chlorine in some circumstances.

The middle third of the bulb 2, for example, is coated inside with MgF₂ (11), thereby implementing safety of switching off when a section 7 of the filament sags so severely that, depending on operating position, it possibly touches the bulb.

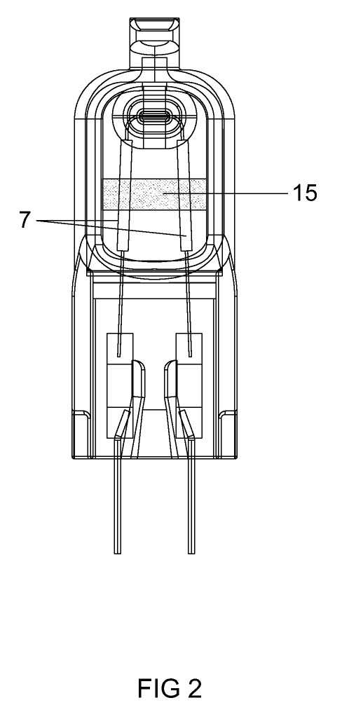

Shown in FIG. 2 is an alternative embodiment in the case of which only a narrow ring 15 at the level of the middle of a luminous section 7 is guided round in a closed fashion in the interior of the bulb. The axial length of the ring is restricted here to at most a third of the length of the luminous section.

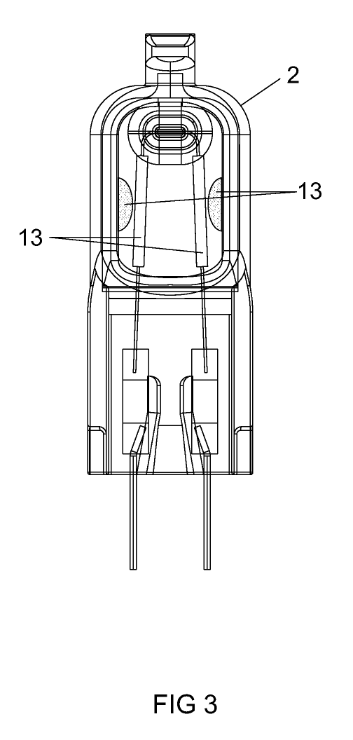

FIG. 3 shows a further example, in the case of which only two coated patches 13 are applied to the bulb 2 in the vicinity of the two sections 7.

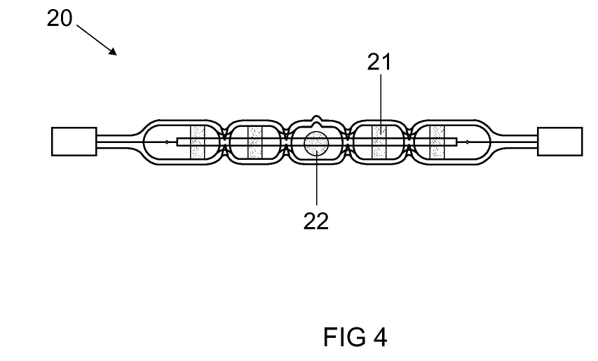

Finally, FIG. 4 shows a soffit lamp 20 that has a plurality of coated rings 21 that are respectively assigned to a section of the luminous element. Only one patch 22 is implemented in the middle, where the tip is seated.

The reactive layer, which mostly contains chlorine, fluorine, bromine, oxides or sulfides, and/or contains alkali or alkaline earth metals which strike arcs, may at least be arranged at the point that comes into consideration as possible point of contact with the luminous element in the case of filament sag. In this case, the criterion of transparency is no longer indispensible, and so even less transparent compounds which, however, extinguish with particular reliability, come into consideration for this purpose.

The layer thickness of the layer to be protected, mostly SiO₂, is in various embodiments not to exceed that of the reactive layer.

The reactive layer is in various embodiments transparent. In another exemplary embodiment, it is at least translucent.

In some circumstances, it can be advantageous to use a scattering layer.

If appropriate, the layer can be configured such that it is locally nontransparent, it is then possible to make use at this point of a particularly reactive material that lacks the property of transparency or is characterized only slightly thereby.

Various embodiments ensure switching off in a reliable and simple way during operation in the event of premature filament sag.

In accordance with various embodiments, the bulb inner wall is partially coated with a specifically suitable substance that begins to evaporate precisely when substantially higher temperatures than in the usual lamp operation are reached owing to the filament touching the bulb. At least regions near the tip and the pinch edge are not coated. During evaporation, substances arise that cause a rapid destruction of the filament by chemical reactions or the striking of an arc in the lamp space. Owing to the rapid destruction of the filament, there is by far no longer enough time available to devitrify the bulb wall. The rapid failure of the lamp thus avoids safety risks.

Alternatively, the bulb wall can also be partially coated with a material that causes destruction of the filament in a solid state reaction given sufficiently high temperatures.

Requirements made of the inner coating of the bulb may be:

The chemical compound is to be stable (no chemical reaction, no fusing) and may not exhibit any marked vapor pressure up to temperatures of at least 300° C., e.g. up to 500° C., up to 800° C. for highly stressed lamps.

A reaction is to take place as far as possible at temperatures above 1000° C.-1100° C.; in this case, substances that destroy tungsten are to be released, or the tungsten is to be destroyed in a solid state reaction. A further possibility is for the material evaporating above 1000° C. to be easy to ionize or to contain ions that easily strike arcs, the result being that the filament is destroyed by arc formation.

The coating should absorb radiation only slightly, that is to say it should in particular cause no significant luminous flux loss. It should be transparent for most applications. It can be of scattered design for specific applications. In exceptional cases, it is possible to accept that narrowly delimited regions of the bulb are coated with an opaque material.

If appropriate, a thin protective SiO₂ layer can be laid over the reactive layer in order to avoid interaction between the coating and the lamp atmosphere.

Possible embodiments may be:

(1) The bulb inner coating consists of MgF₂. In this case, it is in various embodiments only approximately the middle third of the bulb wall, against which the filament firstly bears in the event of sagging, that is coated. Regions near the tip and the pinch edge are not coated. The magnesium fluoride evaporates markedly from approximately 1300 K. During the evaporation MgF₂ is firstly produced; however, it then decomposes at temperatures near the filament with elimination of fluorine. Either the fluorine directly causes rapid destruction of the filament by chemical attack on the cold filament ends, or the fluorine releases oxygen from the bulb wall which is unprotected after the destruction of the MgF₂ layer, or from the uncoated parts of the bulb wall, this oxygen causing destruction of the filament. The thickness of the coating is preferably in the range of 100 nm-1000 nm. The application of coatings of glass walls with MgF₂ is prior art per se. Such coatings can, for example, be executed by means of sol-gel processes—see, for example, WO/2005/097695 and the literature cited therein. Other processes, such as evaporation coating the bulb walls with MgF₂, come into consideration for this purpose.

(2) The use of CaF₂ is possible, similarly. CaF₂ evaporates above approximately 1400 K; at temperatures above 2200 K, the tungsten fluorides are more stable than calcium fluoride, that is to say the filament is rapidly destroyed by fluorine.

(3) The use of AlF₃ is also possible. AlF₃ can, for example, also be applied by using the detour via Al₂O₃. The application of Al₂O₃ is described in DE-A 27 01 051. Reaction with fluorine causes formation on the Al₂O₃ surface of an AlF₃ layer that is activated upon contact with the filament and causes destruction of the filament.

(4) With lamps subjected to relatively low stress, the use of fluorides of the alkali metals is indicated: NaF: marked vapor pressure above 1100 K, KF: marked vapor pressure above 900 K, LiF: from 1000 K.

(5) MgCl₂: evaporation from approximately 1000 K, chlorine in relatively large amounts also causes destruction of the filament.

(6) Polyfluoroethylene and related compounds come into consideration for lamps with relatively large bulbs, and thus bulb temperatures below 300° C. with a filament that is not resting. These compounds evaporate or decompose with accompanying release of HF from temperatures of approximately 300° C.

(7) Also possible is the use of alkali oxides such as Na₂O or K₂0, or of glasses that contain these oxides. If appropriate, it is also possible here to apply a protective SiO₂ layer over the oxidic layer in order to avoid a reaction of the alkali oxides in the glass with the halogen of the fill gas. If the alkalis pass into the lamp interior, they frequently lead to the formation of an arc between the filament limbs, and to the rapid failure of the lamp.

(8) In a further embodiment, the bulb is coated inside with a thin tungsten oxide layer over which an SiO₂ layer is also preferably laid, in order to keep the oxygen partial pressure as low as possible in the case of trouble-free operation. If a filament with a sufficiently high value for the ratio of power to length rests on this layer, then the thin SiO₂ protective layer firstly melts before the tungsten oxide then begins to evaporate. As a result, relatively large quantities of oxygen pass into the lamp interior and cause the rapid failure of the lamp.

In the case of high voltage and medium voltage burners using knob technology 120 V/230 V/240 V with powers from approximately 80 W, the burners are built, in various embodiments, using knob technology, that is to say the filament is fixed overall at up to 5 points, specifically by pinching and by up to 3 knobs. Owing to the fixing of the filament at these 5 points, the filament is excluded in practice from touching the bulb in the event of filament sag. Proceeding from this design, and making use only of one knob, something which is more cost effective, we arrive at an additional advantage: because of the reduced number of heat-dissipating fastening elements, the efficiency of the burners with only one knob is 5%-8% higher than that of the burners with 3 knobs. However, in the case of the burners with only one knob it can happen that filament sag occurs given malfunctions caused by the precursor materials or the production process, and that the filament touches the bulb, explosions being able to occur in the extreme case. In order to avoid this and yet to be able to build efficient lamps with only one knob, it is possible in accordance with the approach to a solution to coat at least one central ring or local points, preferably at least the middle third of the bulb with CaF₂, for example. It is also possible firstly to coat the entire bulb wall, the coating in the region of the knob and the fuse seal being destroyed later in the fabrication process. If the filament comes to rest on the bulb wall during operation of the lamp, the CaF₂ evaporates, fluorine finally being released. The fluorine itself and/or the oxygen released by the reaction of the fluorine with the uncoated parts of the bulb wall cause the rapid destruction of the filament, before critical devitrification of the bulb wall can occur. Thus, if, owing to defective precursor materials or errors in the production process—the filament comes to sag as far as the bulb, the lamp is reliably switched off before devitrification and lamp explosions can occur.

In the case of relatively low powers below approximately 80 W or, more precisely, of appropriately low values for the quotients of power and filament length, and/or in the case of filament fixed at a sufficient number of points, it is possible to relinquish protective measures such as an interior bulb coating, because no devitrification of the bulb wall occurs in the event of the bulb being touched by the filament.

Various embodiments can be applied in particular to the following lamp types:

Halogen incandescent lamps for general lighting and for photo-optic applications, in particular for 220 to 260 V line voltage and with a wattage preferably in the region above 100 W. The particular limiting value of the power from which a critical devitrification can occur when the bulb wall touches the filament depends in detail on the geometric boundary conditions, in particular on bulb diameter, wall thickness and filament length. It must be determined in general by experiment.

Various embodiments permit the production and the distribution of more efficient high voltage halogen lamps of relatively high power that would otherwise not be able to be marketed for reasons of safety against explosion. This relates, for example, to frameless lamps in the case of which the luminous element is held by means of so-called knobs, or the like. It is possible in this case for one or else a plurality of knobs to be used—see EP 446 460, for example.

An application for various embodiments is with high voltage halogen lamps of relatively high power from 100 watts.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A halogen incandescent lamp, comprising:
a bulb in which there are accommodated a luminous element and a fill with a halogen-containing additive;
the halogen being at least one of iodine and bromine,
wherein there is accommodated in the interior of the bulb a layer which can be activated at suitable temperatures, the layer containing at least one of bromine, chlorine, fluorine and oxides or sulfides and is arranged such that it can be touched by the luminous element in the case when the latter is passed through and, during operation of the lamp, ensures the lamp is quickly switched off owing to the release of a reactive substance.

2. The halogen incandescent lamp as claimed in claim 1,
wherein there is accommodated in the interior of the bulb a further layer readily striking an arc, and which contains alkali or alkaline earth metals

3. The halogen incandescent lamp as claimed in claim 1,
wherein the layer comprises at least one of MgF₂; CaF₂; alkali metal fluoride; and MgCl₂; and a mixture thereof.

4. The halogen incandescent lamp as claimed in claim 1,
wherein the layer consists of at least one of MgF₂; CaF₂; alkali metal fluoride; and MgCl₂; and a mixture thereof.

5. The halogen incandescent lamp as claimed in claim 1,
wherein the layer has a thickness of 100 to 1000 nm.

6. The halogen incandescent lamp as claimed in claim 1,
wherein the layer is arranged as a patch or as a surrounding ring.

7. The halogen incandescent lamp as claimed in claim 1,
wherein the operating temperature of the lamp is at most 300°0 C. at the bulb,
wherein the layer comprises an organic fluorine compound.

8. The halogen incandescent lamp as claimed in claim 7,
wherein the operating temperature of the lamp is at most 300° C. at the bulb,
wherein the layer comprises polyfluoroethylene.

9. The halogen incandescent lamp as claimed in claim 1,
wherein the reactive layer is covered with a protective SiO₂ layer.

10. The halogen incandescent lamp as claimed in claim 1,
wherein the layer is transparent.

11. The halogen incandescent lamp as claimed in claim 1,
wherein the layer is configured to be at least one of translucent; locally transparent; and scattering.

12. The halogen incandescent lamp as claimed in claim 1,
wherein the halogen incandescent lamp is configured to be operated directly at line voltage.

13. The halogen incandescent lamp as claimed in claim 12,
wherein the halogen incandescent lamp is configured to be operated at 80 to 250 V.

14. A halogen incandescent lamp, comprising:
a bulb in which there are accommodated a luminous element and a fill with a halogen-containing additive;
the halogen being at least one of iodine and bromine,
wherein there is accommodated in the interior of the bulb a layer which can be activated at suitable temperatures, the layer readily striking an arc, and which contains alkali or alkaline earth metals and is arranged such that it can be touched by the luminous element in the case when the latter is passed through and, during operation of the lamp, ensures the lamp is quickly switched off owing to the release of a reactive substance.

15. The halogen incandescent lamp as claimed in claim 14,
wherein the layer comprises at least one of MgF₂; CaF₂; alkali metal fluoride; and MgCl₂; and a mixture thereof.

16. The halogen incandescent lamp as claimed in claim 14,
wherein the layer has a thickness of 100 to 1000 nm.

17. The halogen incandescent lamp as claimed in claim 14,
wherein the layer is arranged as a patch or as a surrounding ring.

18. The halogen incandescent lamp as claimed in claim 14,
wherein the operating temperature of the lamp is at most 300° C. at the bulb,
wherein the layer comprises an organic fluorine compound.

19. The halogen incandescent lamp as claimed in claim 14,
wherein the reactive layer is covered with a protective SiO₂ layer.

20. The halogen incandescent lamp as claimed in claim 14,
wherein the layer is configured to be at least one of translucent; locally transparent; and scattering.
